(19) United States
(12) Patent Application Publication
(10) Pub. No.: US 2015/0229518 A1
(43) Pub. Date: Aug. 13, 2015

(54) SYSTEMS AND METHODS FOR PROVIDING RAPID PRODUCT DEVELOPMENT FOR SERVICE ASSURANCE

(71) Applicant: MONOLITH TECHNOLOGY SERVICES, INC., St. Charles, IL (US)

(72) Inventor: Shawn Patrick Ennis, Plano, TX (US)

(73) Assignee: MONOLITH TECHNOLOGY SERVICES, INC., St. Charles, IL (US)

(21) Appl. No.: 14/179,705

(22) Filed: Feb. 13, 2014

(51) Int. Cl. H04L 12/24; H04L 12/26

(52) U.S. Cl. CPC H04L 41/0806; H04L 43/08; H04L 41/0869

(57) ABSTRACT

The present disclosure is directed toward systems, methods, and computer program products for providing monitoring services. In one embodiment, the method receives an indication of new product development from a customer for a product and receives initial configuration information from the customer. The method then configures and deploys product monitoring for the product. The method then receives an indication of product deployment from the customer for a product, compiles and packages product monitoring. The method then deploys product monitoring for the product and provides monitoring data to the customer.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS-REFERENCE TO RELATED APPLICATIONS

This application is related to Ser. No. 13/099,572, published as U.S. Patent Pub. No. 2012/0284008, now abandoned; Ser. No. 13/104,663, published as 2012/0290707; Ser. No. 13/099,449, published as U.S. Patent Pub. No. 2012/0284326, now abandoned; Ser. No. 13/099,430, published as U.S. Patent Pub. No. 2012/0284391, now abandoned; and Ser. No. 13/116,066, published as U.S. Patent Pub. No. 2012/0303772. The subject matter of the preceding related applications is incorporated by reference in its entirety.

### BACKGROUND OF THE INVENTION

1. Field of the Invention

The present disclosure relates generally to monitoring computer systems and services. More particularly, the present disclosure relates to systems and methods for implementing a monitoring solution during all stages of product development, from design to operations.

2. Description of Related Art

As network systems grow, the number of devices on the network and the number of services provided by the network likewise multiply. Even for smaller networks, monitoring of network performance and adherence to contractual agreements is of the utmost importance. Even minimal service interruption can have drastic effects on customer relations and revenue derived from the network services.

In order to mitigate potential problems, most network operators employ monitoring tools and strategies for visualizing network performance. Currently, a service is designed and created by a development team whose responsibilities include duties such as designing the network topology, deciding on the hardware and software to implement the service and other initial and secondary considerations prior to deployment. After design and development, many network operators employ a quality assurance team responsible for testing the network service, usually according to well-defined test plans. This quality assurance ensures the proper functionality of the service under well-defined scenarios such as high bandwidth situations and disaster/element failure situations. Often design is again undertaken in response to any identified failures or issues with the service design.

Once a design is thoroughly tested, the service is deployed into active usage, often referred to as operations or development operations (“DevOps”). Deployment may require an additional team within an organization whose primary responsibility is to launch the service and ensure the service is fully operational. At this stage, monitoring is additionally deployed in order to visualize the service performance while the service is operational. This monitoring acts as a “third check,” the first being design and second being quality assurance, to unforeseen issues that may arise in “real world” scenarios. Monitoring provides significant and unique advantages over design and quality assurance as it monitors exactly what scenarios are occurring within the service. Oftentimes, scenarios such as spikes in usage may not be foreseeable for the type of service or designed purpose. By monitoring the active service, DevOps can provide valuable insight to the design and development teams on how the service is performing and what, if any, changes need to be undertaken.

The primary issue with the existing state of the art is the failure to provide monitoring at all stages of the product lifecycle which results in increased lag time when issues are detected during operational monitoring. Furthermore, service launches are frequently delayed due to the temporal requirements of deploying a monitoring solution. For example, often deploying a monitoring solution may require vendor selection, product selection, gathering of service information, and implementation of the monitoring service. These aspects all add to the lead time when launching a product and thus unnecessarily delay the product launch.

Thus, there exists a need in the current state of the art for a monitoring solution that is fully functional during all stages of product development including design and quality assurance. The present disclosure describes such a monitoring solution that provides adaptive and responsive monitoring for products both during design when requirements are changing and operations when product requirements are relatively static. The disclosure additionally describes advantages over the current state of the art in that monitoring may be deployed seamlessly, without the lag time described previously of selecting and implementing a monitoring solution.

### SUMMARY OF THE INVENTION

The present disclosure describes systems, methods and computer program products for providing monitoring services.

Specifically, one embodiment of the system described herein comprises a plurality of configuration servers, a plurality of application servers, and a plurality of monitoring servers. The configuration servers are operative to receive an indication of new product development from a customer for a product and receive initial configuration information from the customer. The configuration servers further configure product monitoring for the product, receive an indication of product deployment from the customer for a product, and deploy product monitoring for the product.

The plurality of application servers are operative to compile and package product monitoring and deploy product monitoring for the product. The plurality of monitoring servers are operative to provide monitoring data to the customer. In one embodiment, the product comprises network service. In another embodiment, the plurality of configuration servers are further operative to validate the initial configuration information. In another embodiment, the plurality of configurations servers are further operative to receive updated configuration information from a customer, reconfigure the product monitoring, and redeploy product monitoring for the product in response to receiving updated configuration information from a customer. In another embodiment, deploying product monitoring comprises generating monitoring information associated with the product wherein monitoring information comprises fault/resolution data, performance and KPI data, KPI data associated KQIs, topology and relationship data, visualization data, or raw usage data.

The disclosure further describes a method for providing monitoring services. The method comprises receiving an indication of new product development from a customer for a product and receiving initial configuration information from the customer. The method then configures and deploys product monitoring for the product. The method further receives an indication of product deployment from the customer for a product, compiles and packages product monitoring. The method further deploys product monitoring for the product and provides monitoring data to the customer.

In one embodiment, the product comprises network service. In another embodiment, the method further comprises validating the initial configuration information. In another embodiment, the method further comprises receiving updated configuration information from a customer. Further, the method may reconfigure and redeploy product monitoring for the product in response to receiving updated configuration information from a customer. In one embodiment, deploying product monitoring comprises generating monitoring information associated with the product, wherein monitoring information comprises fault/resolution data, performance and KPI data, KPI data associated KQIs, topology and relationship data, visualization data, or raw usage data.

Furthermore, the present disclosure is directed towards a non-transitory computer readable media comprising program code that when executed by a programmable processor causes execution of a method for providing monitoring services. The computer readable media comprises computer program code for receiving an indication of new product development from a customer for a product and receiving initial configuration information from the customer. The computer readable media comprises computer program code for configuring and deploying product monitoring for the product. The computer readable media comprises computer program code for receiving an indication of product deployment from the customer for a product, compiling and packaging product monitoring. The computer readable media comprises computer program code for deploying product monitoring for the product and providing monitoring data to the customer.

In one embodiment, the product comprises network service. In another embodiment, the computer readable media further comprises computer program code for validating the initial configuration information. In another embodiment, the computer readable media further comprises computer program code for receiving updated configuration information from a customer. Further, the computer readable media may comprise program code for reconfiguring and redeploying product monitoring for the product in response to receiving updated configuration information from a customer. In one embodiment, computer program code for deploying product monitoring comprises generating monitoring information associated with the product, wherein monitoring information comprises fault/resolution data, performance and KPI data, KPI data associated KQIs, topology and relationship data, visualization data, or raw usage data.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1A and 1B illustrate product lifecycles according to one embodiment of the disclosure;

FIG. 2 illustrates a system for monitoring network products and services according to one embodiment of the present invention;

FIG. 3 illustrates a method for deploying a service with monitoring according to one embodiment of the disclosure;

FIG. 4 illustrates a method for deploying a service with monitoring services according to one embodiment of the disclosure.

### DETAILED DESCRIPTION OF THE INVENTION

In the following description of the embodiments of the disclosure, reference is made to the accompanying drawings that form a part hereof, and in which is shown by way of illustration exemplary embodiments in which the invention may be practiced. It is to be understood that other embodiments may be utilized and structural changes may be made without departing from the scope of the disclosed invention.

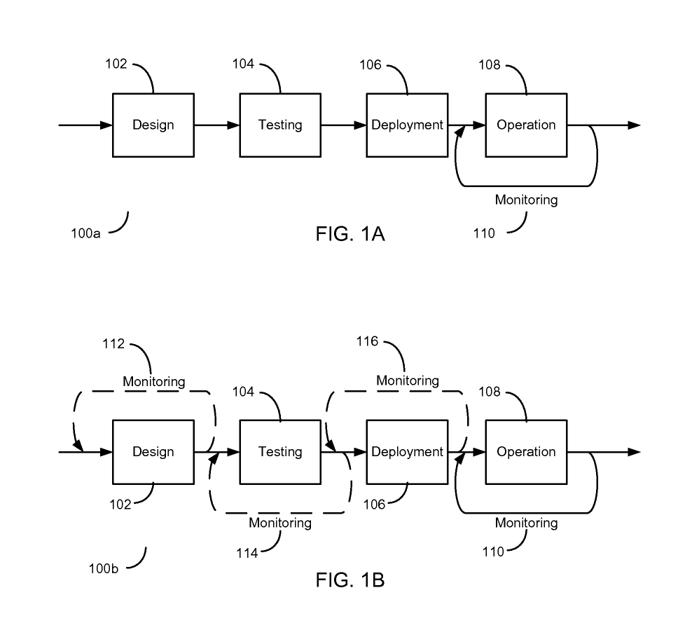

FIG. 1A illustrates a traditional life cycle 100a of a product or service commonly used for network products. As used herein, network “products” or “services” both generally refer to computing services implemented over computer networks. Notably, however descriptions of network-connected products and services are provided primarily as an exemplary embodiment and are not intended to be limiting. In alternative embodiments, products or services may refer to products or services implemented using any type of communications channels, not necessarily limited to products and services used in the creation of network-based products or services. For example, products and services may comprise software packages or services such as e-mail services, HTTP services, etc.

Generally, the products or services having a lifecycle 100a are designed and developed, 102, by in-house development teams or, alternatively, third party development teams. Design and development may comprise all aspects of such stage such as determining a product or service network topology, developing custom software for said product or service, determining the appropriate hardware, determining the levels of service for sub-services within the network products or services, etc.

After the product or service is developed, the product or service is tested, 104 often at times by a separate quality assurance (QA) team or group. Testing may include load or stress testing, performance testing, functional testing, regression testing, security testing, usability testing, etc. When the product or service is appropriately tested, the product or service is deployed, 106, and placed into operation, 108.

After a product or service is deployed and placed into operation the product or service may be continually monitored, 110. In this illustration, monitoring may comprise monitoring faults and resolutions, performance and KPIs, KPIs associated with KQIs, network topology, etc. Notably however, as illustrated in FIG. 1A, monitoring is only implemented after, or as part of, operations. Thus, any faults, resolutions, or other issues are only detected while a product or service is in operation. Often, such issues require modifications or changes to the product or service which would result in the design, testing, and deployment of changes resulting in increases in delays due to the re-execution of steps 102 through 108 for any issue arising from said monitoring 110.

FIG. 1B illustrates an improved product lifecycle according to one embodiment of the present invention. As illustrated in FIG. 1B, a product lifecycle may comprise a design 102, testing 104, deployment 106, and operation 108 phase similar to the lifecycle depicted in FIG. 1A. Furthermore, an improved product lifecycle may employ monitoring 110 while the product is operation.

However, in contrast to lifecycle 100a, the improved product lifecycle 100b further comprises a plurality of monitoring stages 112, 114, and 116 operative through each state of the product lifecycle. Notably, the improved lifecycle moves monitoring of services “left” in that monitoring may be deployed during all stages of product development. As such, monitoring “evolves” alongside of the product reducing downtime or lag when monitoring is eventually deployed into an operational network or system.

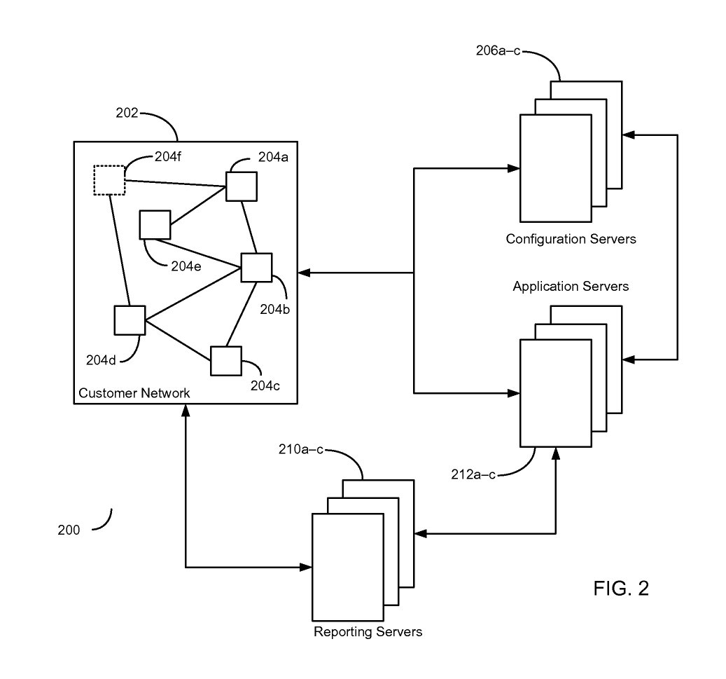

FIG. 2 illustrates a system for monitoring network products and services according to one embodiment of the present invention. As illustrated in FIG. 2, a system 200 includes a customer network 202, which may comprise a plurality of network elements or service 204a-f. Some of these elements or services may be in operation (e.g., elements/services 204a-e) while others (e.g., element/service 2040 may be in various stages of development (e.g., design, testing, etc.). Notably, while FIG. 2 illustrates six elements/services 204a-f, the disclosed invention is not limited to any specific number of such elements or services. Furthermore, a customer network may comprise a plurality of devices or services that are not part of a network product or service (not pictured). Such devices may comprise standard enterprise computing devices such as workstations or internally used servers. In alternative embodiments, elements or services 204a-f may comprise software applications and/or hardware associated with said software applications. For example, elements or services 204a-f may comprise various components of a software services such as load balancers, IMAP servers, or other services associated with an e-mail service. In this example, elements or services 204a-f may comprise the e-mail software implementing the e-mail services, while in alternative embodiments elements or services 204a-f may comprise the hardware executing the e-mail software.

A customer network 202 may be communicatively coupled to configuration servers 206a-c, application servers 208a-c, and reporting servers 210a-c. In some embodiments, the customer network 202 may communicate with servers 206a-c, 208a-c, and 210a-c via a wide area network such as the Internet. In other embodiments, a combination of servers 206a-c, 208a-c, and 210a-c may be locally present within a customer network (e.g., a private WAN or LAN).

Configuration servers 206a-c may be configured to receive data from customer network 202 such as data relating to products or services in development. For example, configuration servers 206a-c may be configured to receive data relating to the type of service, endpoints utilized by the service, service levels required, etc. Configuration servers 206a-c may further be configured to store the configuration data and/or provide the configuration data to the plurality of application servers 208a-c. In the illustrated embodiment, configuration servers 206a-c may provide a user interface to allow users to graphically create, update, read and delete configuration data.

Application servers 208a-c may be configured to receive data from configuration servers 206a-c and coordinate active and/or passive monitoring of devices and/or services within customer network 202. Further, application servers 208a-c may be configured to receive continual updates from configuration servers 206a-c, and, thus, implicitly from customer network 202, as products or services 204a-f are modified or reconfigured. In this manner, application servers 208a-c may configure any monitoring processes running on said servers in response to updated configuration information. For example, if, as part of product development, customer network 202 adds additional devices to the network 202, the customer may transmit newly updated configuration information to configuration servers 206a-c which in turns informs the application servers 208a-c of such a change. In response, application servers 208a-c may update a profile associated with the customer to active or passively monitor the newly added device. Although illustrated as a single set of application servers 212a-c, alternative embodiments exist wherein there may exist a second set of application servers wherein the additional set of servers is utilized solely for operations monitoring while servers 212a-c are utilized exclusively for development and testing monitoring. For example, servers utilized solely for development and/or testing may be optimized for frequent configuration changes and thus higher bandwidth utilization.

Application servers 212a-c may further be coupled to monitoring storage (not illustrated). While application servers 212a-c are active and/or passively monitoring products within customer network 202, the servers 212a-c may store the gathered data for later usage. In one embodiment, the servers 212a-c may identify the data based on the product lifecycle stage. In this manner, subsequent retrieval may be able to visualize data and performance during the development of the product. In alternative embodiments, application servers 212a-c may additionally employ versioning control in order to track development changes across time. Thus, a customer may be able to analyze monitoring data against differing versions of the product in order to determine the effectiveness of different versions of the product or service. In such embodiments, various versioning control software may be utilized such as Get, Subversion, Mercurial, or similar systems.

Application servers 208a-c may be further communicatively coupled to reporting servers 210a-c and may transmit event data or other reporting data to the servers 210a-c. In the illustrated embodiment, application servers 208a-c may transmit data such as fault/resolution data, performance and KPI data, KPI data associated KQIs, topology and relationship data, visualization data, and various other raw usage data. Reporting servers 210a-c process the raw usage data and generate a plurality of reporting metrics. Reporting servers 210a-c may present such data to the customer network 202 (e.g., to developers, quality assurance, or other business units) via a graphical user interface such as a web-based reporting interface.

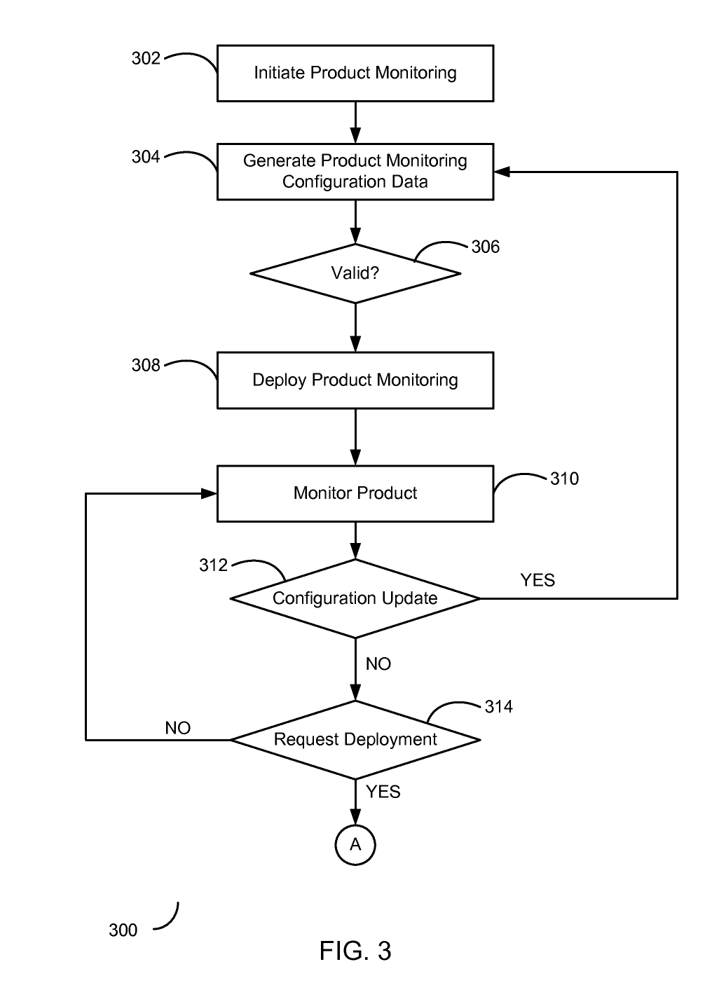

FIG. 3 illustrates a method for deploying a service with monitoring according to one embodiment of the present invention. According to the embodiment that FIG. 3 illustrates, a method 300 initializes product monitoring, step 302. In one embodiment, initiating product monitoring may comprise receiving an indication from a customer regarding product development such as an indication that the customer is beginning to develop a new product. In one embodiment, an indication may be received from an e-commerce platform indicating that a customer has registered for product monitoring or a similar process. Alternatively, initializing monitoring may be undertaken after input from a method provider's sales team or other internal process.

After initiating product monitoring, step 302, the method 300 generates product monitoring configuration data, step 304. In the illustrated embodiment, generating product monitoring configuration data may comprise generating data regarding a product being developed by a customer. For example, product configuration data may include fault/resolution data, performance and KPI data, KPI data associated KQIs, topology and relationship data, visualization data, and various other raw usage data. In one embodiment, the method 300 may generate this data based on input transmitted by a customer to a monitoring provider. For example, the method 300 may receive input data from a web-based interface wherein customers may enter in product configuration details.

The method 300 then determines if the configuration data is valid, step 306. If the configuration data is valid, the method 300 deploys product monitoring, step 308. If the data is not valid, the method 300 may continue to receive configuration data, such as via a web-based interface that alerts customer as to any validation errors.

As discussed previously, the method 300 may actively and/or passively monitor network elements and/or services being deployed by a customer network. In one embodiment, the method 300 may utilize the endpoint data (from the service information) and the endpoint configuration data (from the template) to identify the network elements (e.g., using SNMP) received previously, and configure the network elements to function within the service parameters. For example, the method 300 may configure the network elements to accept certain types of traffic and guarantee requested service levels requested by the customer. The method 300 may additionally set an activation data and/or time wherein the configuration is delayed until such a date and/or time. The method 300 may additionally configure network elements to handle the parsing of requests in various protocols, feeds, or formats. The method 300 may additionally notify the customer upon the successfully activation of the service and provide information (such as portal information) that allows the customer to monitor, update, or add new functionality to the service. Additionally, the method 300 may automatically configure active and/or passive monitoring of the elements and the newly deployed service.

The method 300 then monitors the product or service, step 310. As discussed such monitoring may be active and/or passive. As part of this process, the method 300 may configure the service to monitor events and other data that occur as part of the service operation. In one embodiment, the method 300 may utilize an existing monitoring infrastructure thus providing a unified monitoring interface with other monitoring performed for the customer. When events occur with respect to the service, the method 300 records said events and processes the events to provide a visualization of activity and events within the network and associated with the service. These visualizations may be provided via a reporting interface. In one embodiment, the visualizations may be provided within a customer portal as described previously.

The method 300 continues to monitor the product, step 310, until either a configuration update occurs, step 312, or a deployment request is received, step 314. As discussed previously, the method 300 is capable of providing monitoring services through the development lifecycle of a product, as such, the method 300 is configured to receive configuration updates from a customer/developer periodically during the product development lifecycle. For example, a customer may add network elements to a product during development such as router, switches, etc. as the need for these network elements arises. As such, the customer may transmit data indicating the inclusion (or removal) of network elements or services to the method 300. In this manner, customers are able to make informed decisions regarding how their products and services are developed based on monitoring services similar to those previously only utilized during operations. In addition to physical or logical devices and services, a configuration update may additional include receiving updated knowledge regarding the product or service including, but not limited to, KPI/KQI data, fault data, correlation policies, process and procedures. Updated knowledge may be transmitted and updated to allow for modifications in the product or service design based on monitoring information. In this manner, knowledge can be packaged iteratively throughout the development process. That is, the knowledge relating to a product or service can be logically grouped or combined in a predefined format and stored in a structured manner for subsequent retrieval. For example, knowledge can be stored in a serializable format and archived as a single, flat file which may be versioned, transferred, and executed as needed to provide monitoring services.

Alternatively, the method 300 may receive a request to deploy the product or service, step 314. In this step, a customer has completed development of the product or service and wishes to deploy the service for operation.

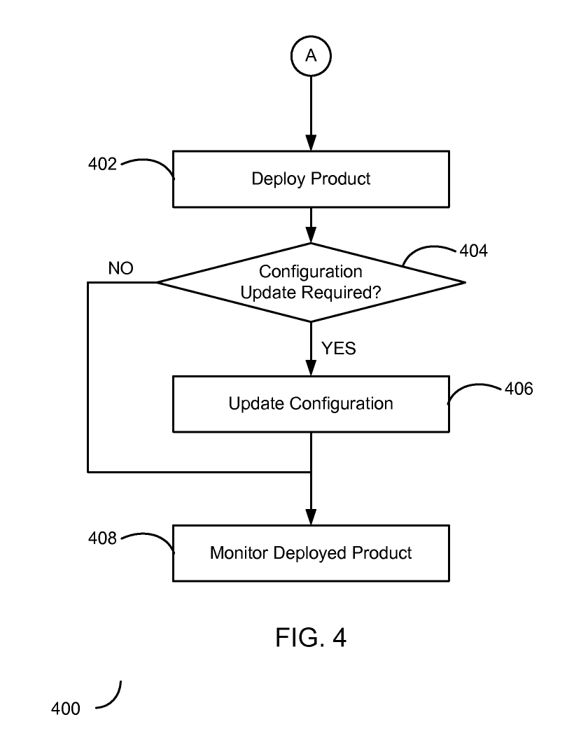

FIG. 4 illustrates a method for deploying a service with monitoring services according to one embodiment of the disclosure. As the embodiment of FIG. 4 illustrates, a method 400 previous receives a request for deployment, step 314. In response, the method 400 deploys the product or service monitoring, step 402. In one embodiment, deploying a product or service may comprise compiling and packaging intellectual property generated during the development of a product or service. For example, compiling and packaging may include performing optimizations to the monitoring service due to the lack of frequent changes to the product or service during operation, as compared to frequent adjustments made during development and testing. In this manner, monitoring may be optimized or finalized for operational usage.

Additionally, as discussed previous, knowledge regarding the monitoring may be iteratively packaged through development. Upon determining that a product or service is to be deployed, the method 400 is capable of migrating this knowledge into the deployed product or service. For example, upon deployment the method 400 may utilize the last iteration of knowledge received from the customer and deploy monitoring based on the latest iteration. In this manner, upon deployment, the method 400 is capable of seamlessly incorporating the knowledge developed during the design and testing stages of product or service development.

After configuring and deploying monitoring for a product or service, the method 400 determines if a configuration update is required, step 404. Similar to updating a configuration during development, the method 400 may receive an indication from a customer that the monitoring of a deployed product or service must be updated. For example, the customer may add or remove additional network elements to the product or service during operation and thus require a change in the monitoring. As another example, the customer may replace or upgrade hardware associated with a product or service and thus must configure the monitoring service to monitor the changed hardware.

If a change is requested, the method 400 updates the configuration as required, step 406. Updating a configuration may be similar to the act of updating the configuration during development and is not repeated herein for the sake of clarity.

Upon receiving such an update, the method 300 reconfigures the monitoring service by generating monitoring configuration data, step 304 for the updated product. In this manner, a customer may continuously update monitoring services as they are developing products providing valuable insight into the performance of the product during all stages of development.

FIGS. 1 through 4B are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a non-transitory machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to non-transitory media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for providing monitoring services, the method comprising:
receiving an indication of new product development from a customer for a product;
receiving initial configuration information from the customer;
configuring and deploying product monitoring for the product;
receiving an indication of product deployment from the customer for a product;
compiling and packaging product monitoring;
deploying product monitoring for the product; and
providing monitoring data to the customer.

2. The method of claim 1 wherein the product comprises network service.

3. The method of claim 1 further comprising: validating the initial configuration information.

4. The method of claim 1 further comprising: receiving updated configuration information from a customer.

5. The method of claim 4 further comprising: reconfiguring and redeploying product monitoring for the product in response to receiving updated configuration information from a customer.

6. The method of claim 1 wherein deploying product monitoring comprises generating monitoring information associated with the product.

7. The method of claim 6 wherein monitoring information comprises fault/resolution data, performance and KPI data, KPI data associated KQIs, topology and relationship data, visualization data, or raw usage data.

8. A system for providing monitoring services, the method comprising:
a plurality of configuration servers operative to:
receive an indication of new product development from a customer for a product;
receive initial configuration information from the customer;
configure product monitoring for the product; and
receive an indication of product deployment from the customer for a product;
deploy product monitoring for the product;
a plurality of application servers operative to compile and package product monitoring; and deploy product monitoring for the product; and
a plurality of monitoring servers operative to provide monitoring data to the customer.

9. The system of claim 8 wherein the product comprises network service.

10. The system of claim 8 wherein the plurality of configuration servers are further operative to validate the initial configuration information

11. The system of claim 8 wherein the plurality of configurations servers are further operative to receive updated configuration information from a customer, reconfigure the product monitoring, and redeploy product monitoring for the product in response to receiving updated configuration information from a customer.

12. The system of claim 8 wherein deploying product monitoring comprises generating monitoring information associated with the product.

13. The system of claim 12 wherein monitoring information comprises fault/resolution data, performance and KPI data, KPI data associated KQIs, topology and relationship data, visualization data, or raw usage data.

14. Non-transitory computer readable media comprising program code that when executed by a programmable processor causes execution of a method for providing monitoring services, the computer readable media comprising:
computer program code for receiving an indication of new product development from a customer for a product;
computer program code for receiving initial configuration information from the customer;
computer program code for configuring and deploying product monitoring for the product;
computer program code for receiving an indication of product deployment from the customer for a product;
computer program code for compiling and packaging product monitoring;
computer program code for deploying product monitoring for the product; and
computer program code for providing monitoring data to the customer.

15. The computer readable medium of claim 14 wherein the product comprises network service.

16. The computer readable medium of claim 14 further comprising: computer program code for validating the initial configuration information.

17. The method of claim 1 further comprising: receiving updated configuration information from a customer.

18. The computer readable medium of claim 17 further comprising: computer program code for reconfiguring and redeploying product monitoring for the product in response to receiving updated configuration information from a customer.

19. The computer readable medium of claim 14 wherein computer program code for deploying product monitoring comprises computer program code for generating monitoring information associated with the product.

20. The computer readable medium of claim 19 wherein monitoring information comprises fault/resolution data, performance and KPI data, KPI data associated KQIs, topology and relationship data, visualization data, or raw usage data.
